(19) United States
(12) Patent Application Publication
(10) Pub. No.: US 2010/0318983 A1
(43) Pub. Date: Dec. 16, 2010

(54) METHOD FOR INSTALLING PATCH FILE

(75) Inventors: LIANG-MAO HUNG, Tu-Cheng (TW); CHIH-YUAN CHUANG, Tu-Cheng (TW); CHIA-HUNG CHIEN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/612,473

(22) Filed: Nov. 4, 2009

(30) Foreign Application Priority Data
Jun. 12, 2009 (CN) 200910303199.4

(51) Int. Cl. G06F 9/44

(52) U.S. Cl. 717/168

(57) ABSTRACT

A computer-implemented method for installing patch files to a local storage of an embedded electronic device includes the following steps. A file header is read and an original checksum value is received from the file header. Patch files from a data package are written to a data area of the local storage. A checksum value of the patch files written in the data area is calculated. The checksum value with the original checksum value is compared to determine integrality of the patch files.

### BACKGROUND

1. Technical Field

The disclosure generally relates to methods for installing patch files in an embedded electronic device.

2. Description of Related Art

Conventional embedded electronic devices, such as digital cameras, set-top boxes, digital phone frames etc. usually have firmware or software to enable the device's basic operation as well as implementing higher-level functions. When these devices have security vulnerabilities, bugs, a firmware or software patch is needed. The patch may be destroyed or be lost when transmitting from the internet or some storage devices. So there is a need to check the patch before it is installed to the device.

### BRIEF DESCRIPTION OF THE DRAWINGS

FIG. 1 is a block view showing a linking relationship between a patch package and a local storage according to an embodiment.

FIG. 2 is block view of a file header of FIG. 1.

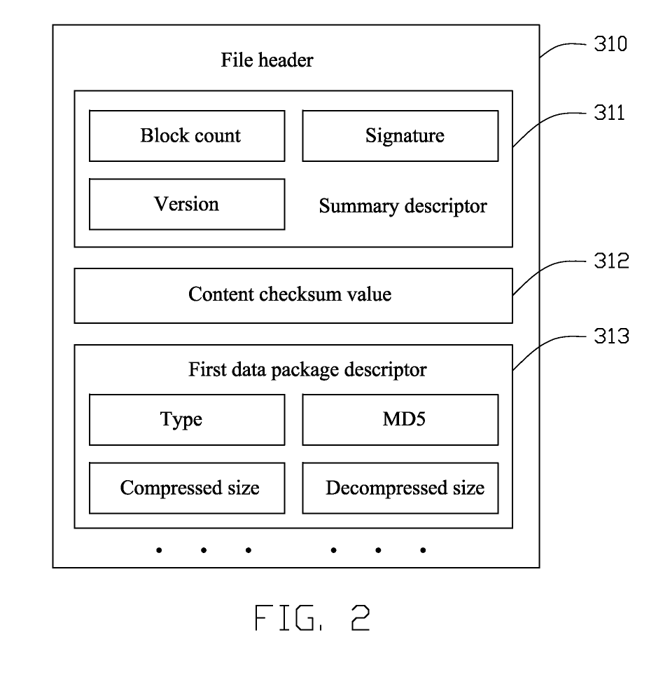

FIG. 3 is a flowchart of a method for installing patch files according to the embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

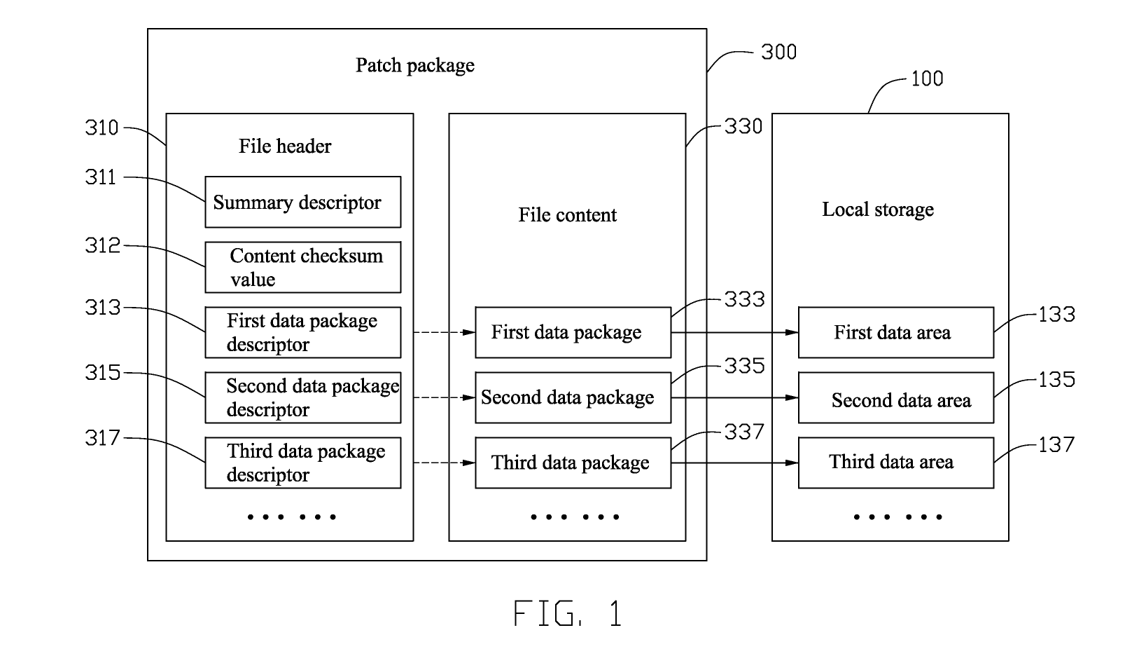

Referring to FIG. 1, an electronic device with an embedded system includes a local storage 100. The local storage 100 can be disk storage installed with firmware. The local storage is divided into a plurality of data areas physically. Each data area can store a plurality of patch files. The data areas include a first data area 133, a second data area 135, and a third data area 137, etc.

A patch package 300 can be stored in a USB storage device. The patch package 300 is provided to upgrade files in the local storage 100. The patch package 300 includes a file header 310 and file content 330. The file content 330 includes a plurality of data packages. The data packages include a first data package 333 corresponding to the first data area 133, a second data package 335 corresponding to the second data area 135, and a third data package 337 corresponding to the third data area 137, etc. Each data package stores a plurality of patch files.

The file header 310 includes a data package descriptor package metadata, a content checksum value 312, and a plurality of descriptors. The summary descriptor 311 stores at least one of a total count of the data package, version information, signature information, and type information of a to-be-updated electronic device. The content checksum value 312 is obtained using the message-digest algorithm 5 (MD5) value. The data package descriptors include a first data package descriptor 313 corresponding to the first data package 333, a second data package descriptor 315 corresponding to the second data package 335, and a third data package descriptor 317 corresponding to the third data package 337. Patch files in the data packages are compressed and encrypted by advanced encryption standard (AES). Each of the data package descriptor stores the address location of the file patch, a file patch checksum value, compressed file size of the patch files, and decompressed file size of the patch files. For example, the first data package descriptor 313 stores the address location of the file patch 333 of the patch package 300, a checksum value of the first data package 333, a compressed file size of the patch files, and a decompressed file size of the patch files in the first data package 333.

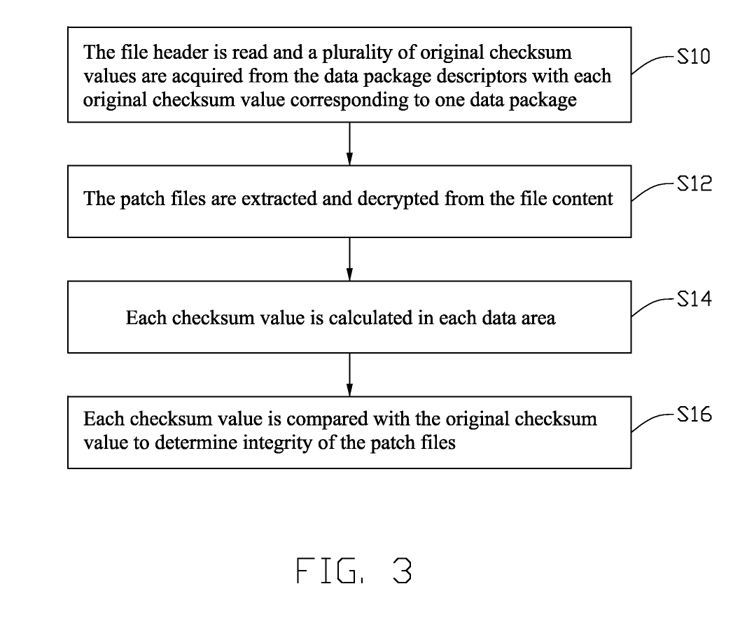

Referring to FIG. 3, a method for installing patch files to a local storage of an embedded electronic device according to the embodiment includes the following steps.

In step 10, the file header 310 is read and a plurality of original checksum values are acquired from the data package descriptors with each original checksum value corresponding to one data package. Before reading the file header, the file header and the data package are decrypted.

In step 12, the patch files are extracted and decrypted from the file content 330. The extracted and decrypted patch files are written to the data areas of the application storage 100. Before writing the patch files to the data area, the integrity of the patch files are checked.

In step 14, each checksum value is calculated in each data area.

In step 16, each checksum value is compared with the original checksum value to determine integrity of the patch files.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A computer-implemented method for installing patch files to a local storage of an embedded electronic device, the method comprising:
reading a file header and acquiring an original checksum value from the file header;
writing patch files from a data package to a data area of the local storage;
calculating a checksum value of the patch files written in the data area; and
comparing the checksum value with the original checksum value to determine integrality of the patch files.

2. The method of claim 1 further comprising decrypting the file header and the data package before reading the file header.

3. The method of claim 2, wherein the file header and the data package are encrypted by advanced encryption standard.

4. The method of claim 1 further comprising decompressing the patch files before writing the patch files to the data area.

5. The method of claim 1, wherein the local storage is a disk storage installed with firmware.

6. The method of claim 1, wherein the original checksum value and the checksum value are message-digest algorithm 5 (MD5) values.

7. The method of claim 1 further comprising checking integration of data package in the data area before writing patch files to the data area.

8. A storage medium having stored thereon instructions that, when executed by a processor, causing the processor to perform a method for controlling operations on a user interface of an electronic device, wherein the method comprises:
reading a file header and acquiring an original checksum value from a patch package;
writing patch files from a data package to a data area of a local storage;
calculating a checksum value of the patch files written in the data area; and
comparing the checksum value with the original checksum value to determine integrality of the patch files.

9. The method of claim 8, wherein the method further comprises decrypting the file header and the data package before reading the file header.

10. The method of claim 9, wherein the file header and the data package are encrypted by advanced encryption standard.

11. The method of claim 8 further comprising decompressing the patch files before writing the patch files to the data area.

12. The method of claim 8, wherein the local storage is a disk storage installed with firmware.

13. The method of claim 8, wherein the original checksum value and the checksum value are message-digest algorithm 5 (MD5) values.

14. The method of claim 8 further comprising checking integration of data package in the data area before writing patch files to the data area.
